(19) United States
(12) Patent Application Publication
(10) Pub. No.: US 2006/0238999 A1
(43) Pub. Date: Oct. 26, 2006

(54) Light device

(76) Inventor: Yuan Tzu Cheng, Taichung (TW)

Correspondence Address: CHARLES E. BAXLEY, ESQ., 90 JOHN STREET, THIRD FLOOR, NEW YORK, NY, 10038, US

(21) Appl. No.: 11/080,015

(22) Filed: Mar. 14, 2005

(51) Int. Cl. B60Q 1/26

(52) U.S. Cl. 362/227

(57) ABSTRACT

A light device includes a number of brackets disposed on a base board, and a number of light members engaged in the brackets respectively, for attaching to the base board. The light members are made of light emitting diodes and arranged in series, to generate a light of an increased brightness, and to have an increased working life. The light members will not generate a great heat such that the working life of the light members may further be increased. A control device may be coupled to the light members, to control and to operate the light members. A number of driving devices may be coupled to the light members and the control device, to control and to operate the light members to generate lights of different colors.

### BACKGROUND OF THE INVENTION

1. Field of the Invention

The present invention relates to a light device, and more particularly to a light device having a series of light members for generating stronger light and for increasing the working life of the light device.

2. Description of the Prior Art

Typical computer facilities, such as portable computers, comprise a number of light bulbs disposed therein, such as disposed within the screen or the frame for supporting the liquid crystal display therein, in order to generate lights and to light the typical computer facilities. However, the typical light bulbs may generate a great heat, and may consume a relatively greater electric energy, and may have a relatively shorter working life.

For increasing the working life of the light devices for the typical computer facilities, a fewer number of the typical light bulbs or light emitting devices have been used, and a refractive planar member is further provided for transmitting the light generated by the typical light bulbs or light emitting devices, and the refractive planar member is partially exposed for allowing the users to see the light.

For example, U.S. Pat. No. 6,773,125 to Chen discloses one of the typical light devices comprising a light bulb or light emitting member and a refractive planar member coupled to the light bulb or light emitting member, for transmitting the light generated by the typical light bulb or the light emitting member. However, the light generated by the typical light devices is weak and may not suitably light the screen or the liquid crystal display of the typical computer facilities.

The present invention has arisen to mitigate and/or obviate the afore-described disadvantages of the conventional light devices for computer facilities.

### SUMMARY OF THE INVENTION

The primary objective of the present invention is to provide a light device including a series of light members coupled in parallel to each other, for generating a stronger light and for increasing the working life of the light device.

In accordance with one aspect of the invention, there is provided a light device comprising a base board including a number of brackets disposed thereon, and a number of light members engaged in the brackets respectively, for attaching to the base board. The light members are made of light emitting diodes and arranged in series, to generate a light of an increased brightness, and to have an increased working life. The light members will not generate heat such that the working life of the light members may further be increased.

The light members each includes two prongs extended therefrom, for coupling to the base board. The light members each includes an indicator attached to each of the prongs, for showing the electrodes of the prongs.

A control device may further be provided and coupled to the light members, to control and to operate the light members. A number of driving devices may further be provided and coupled to the light members respectively, and coupled to the control device, to control and to operate the light members to generate lights of different colors.

A transformer may further be provided and coupled to the light members respectively, and coupled to the control device, to transform and to provide a suitable electric energy to the light members. A photosensitive device may further be provided and coupled to the control device, to detect whether the users are standing beside or operating the light device or not.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of portable computer having a light device in accordance with the present invention;

FIG. 2 is a perspective view of the light device;

FIG. 3 is a perspective view illustrating one of the light members of the light device;

FIG. 4 is a top plan view of the light member of the light device;

FIG. 5 is a side plan view of the light member of the light device;

FIG. 6 is a block diagram illustrating the control circuit for the light device;

FIGS. 7A, 7B, 7C are partial plan views illustrating one of the arrangements of the light member of the light device;

FIGS. 8A, 8B, 8C are partial plan views similar to FIGS. 7A, 7B, 7C, illustrating the other arrangements of the light member of the light device;

FIGS. 9A, 9B, 9C are partial plan views similar to FIGS. 7A, 7B, 7C, and FIGS. 8A, 8B, 8C, illustrating the further arrangements of the light member of the light device;

FIG. 10 is a perspective view illustrating the other application of the light device; and

FIG. 11 is another perspective view illustrating the further application of the light device.

### DETAILED DESCRIPTION OF THE PREFERRED EMBODIMENT

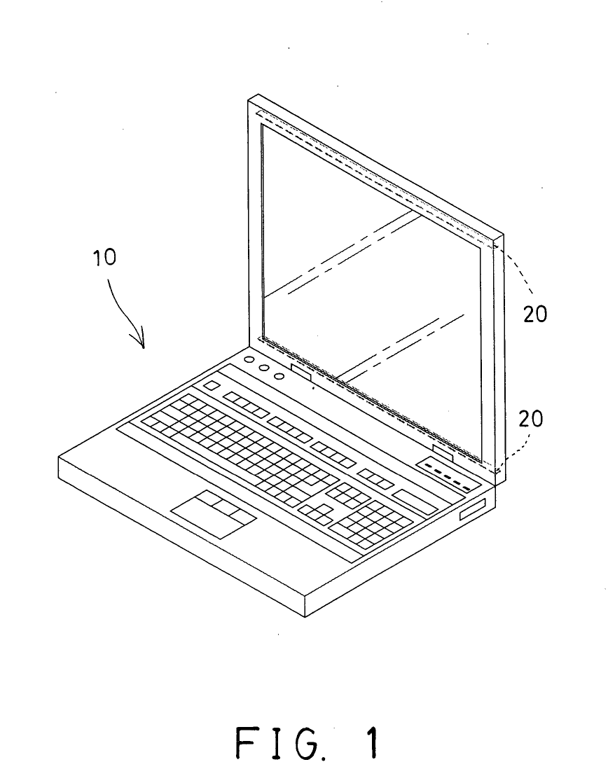

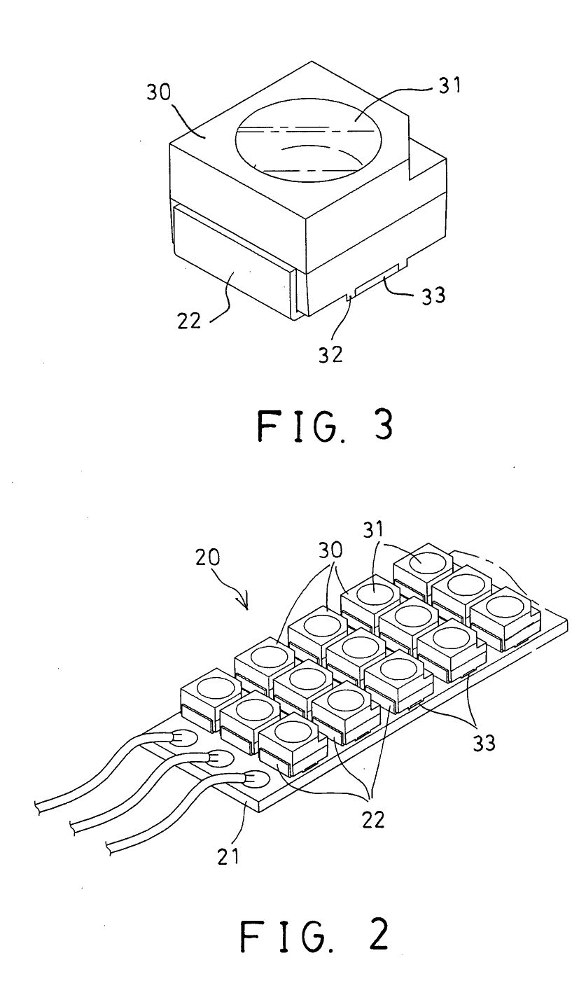

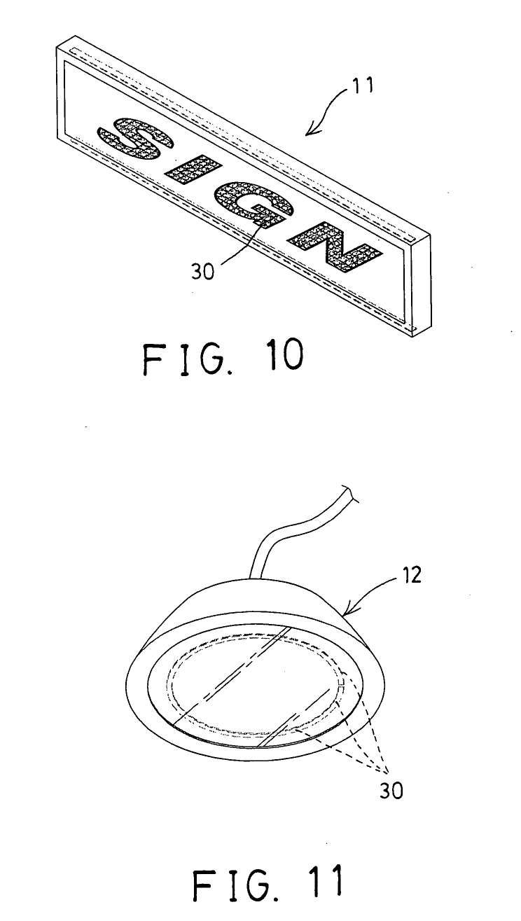

Referring to the drawings, and initially to FIGS 1 and 2, a light device 20 in accordance with the present invention may be provided for attaching or engaging into various objects 10, such as the computer facilities, portable computers 10 (FIG. 1), advertise signs 11 (FIG. 10), peripheral light devices 12 (FIG. 11), etc., for generating lights to light the objects 10.

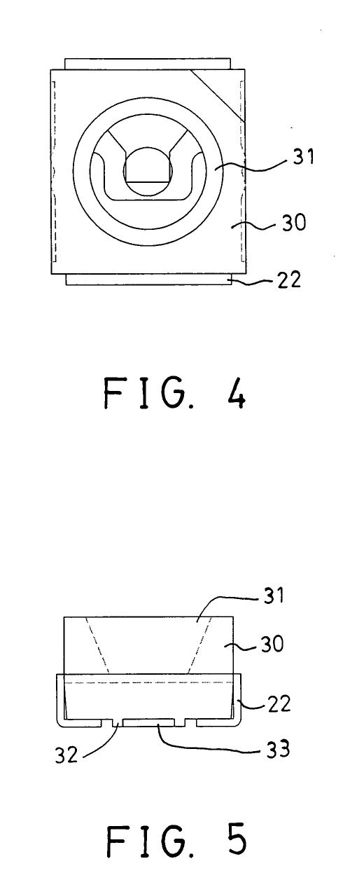

For example, as shown in FIGS. 2-6, the light device 20 comprises a base board 21 including a number of brackets 22 disposed thereon and arranged in line or in series or in matrix arrangement relative to each other, and a number of light members 30 attached or supported in or engaged in the brackets 22 respectively. The base board 21 may be made of hard or solid materials, or soft or flexible materials.

As best shown in FIGS. 3-5, each of the light members 30 includes an opening or a window 31 formed in top thereof, for allowing the light to emit out through the window 31, and includes two poles or prongs 32 extended therefrom, for engaging with or for electrically coupling to the base board 21. It is preferable that the light members 30 each includes a sign or an indicator 33 attached to each of the prongs 32, for showing or indicating the electrodes of the prongs 32.

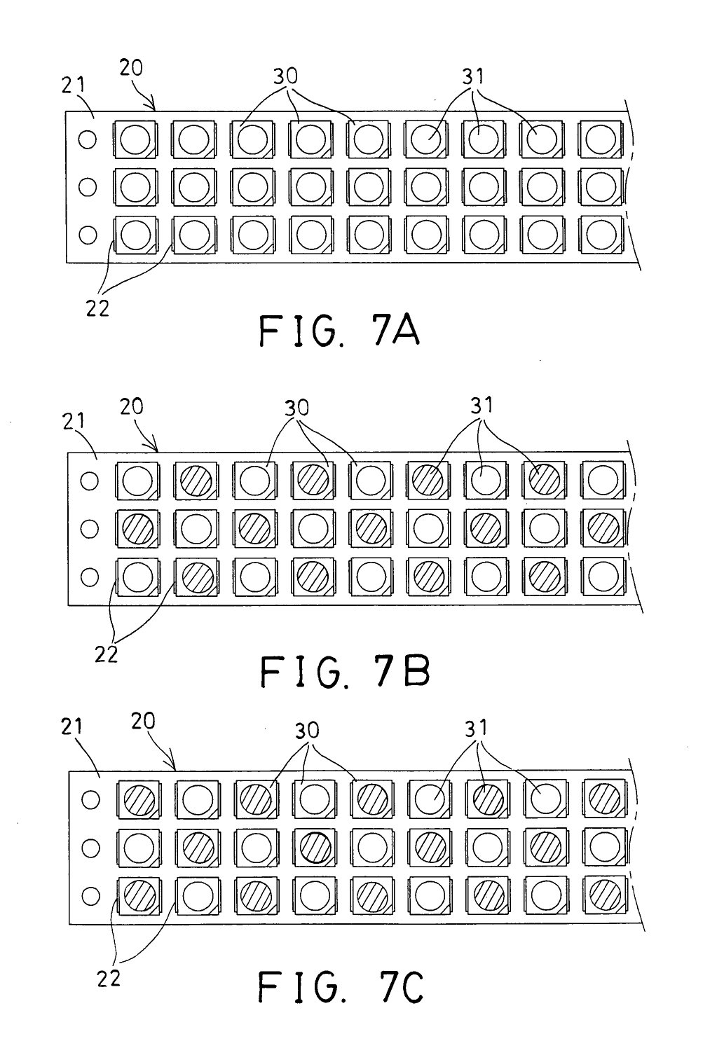

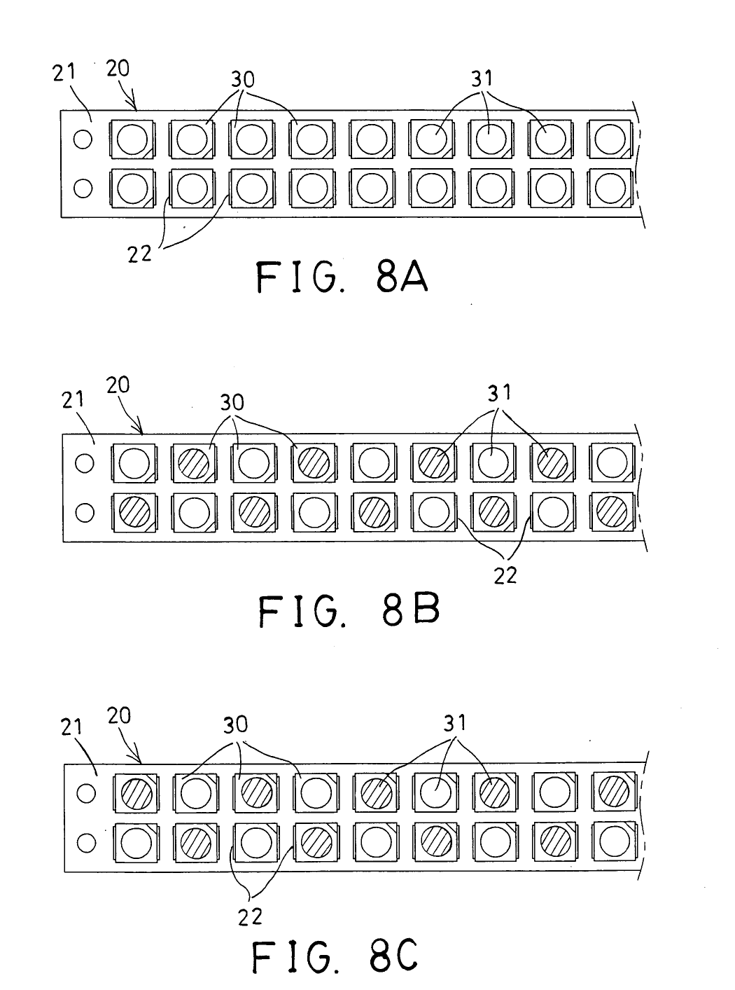

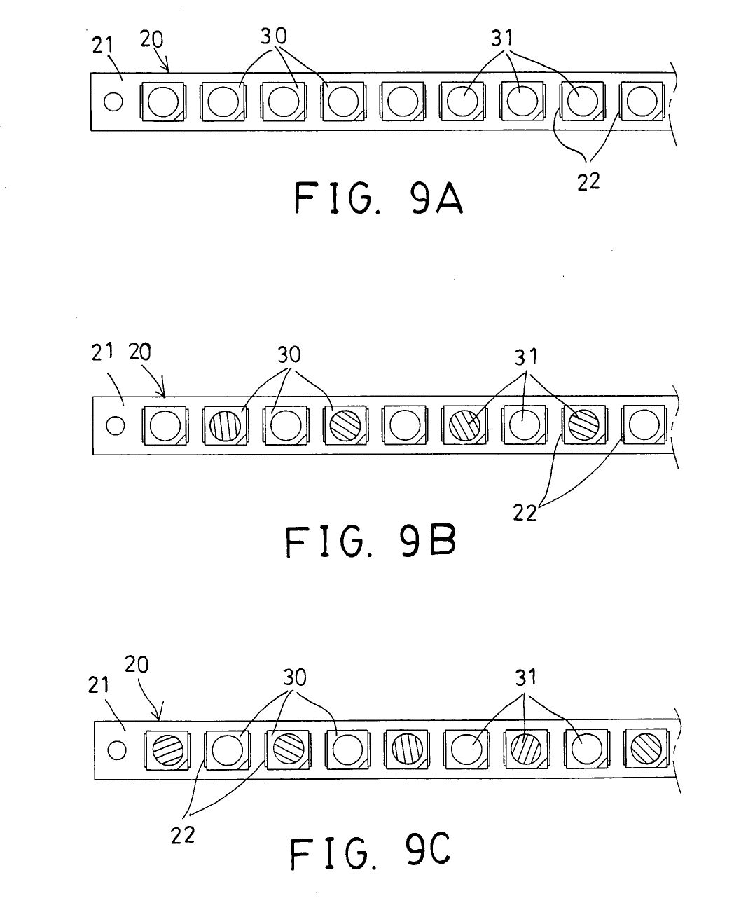

It is to be noted that the light members 30 may be disposed or arranged in one or more lines, or arranged in a matrix arrangement, such as arranged in three lines, as shown in FIGS. 7A, 7B, 7C, or in two lines as shown in FIGS. 8A, 8B, 8C, or in one line as shown in FIGS. 9A, 9B, 9C. It is preferable that the light members 30 are made of light emitting diodes, dot diode (DD), or the like.

However, the arrangements as shown in FIGS. 7A-7C, 8A-8C, and 9A-9C are provided for illustration purposes only, the light members 30 may also be disposed or arranged in the other arrangements, such as in a circular arrangement as shown in FIG. 11, or in the other arrangements as shown in FIG. 10 for such as advertising purposes.

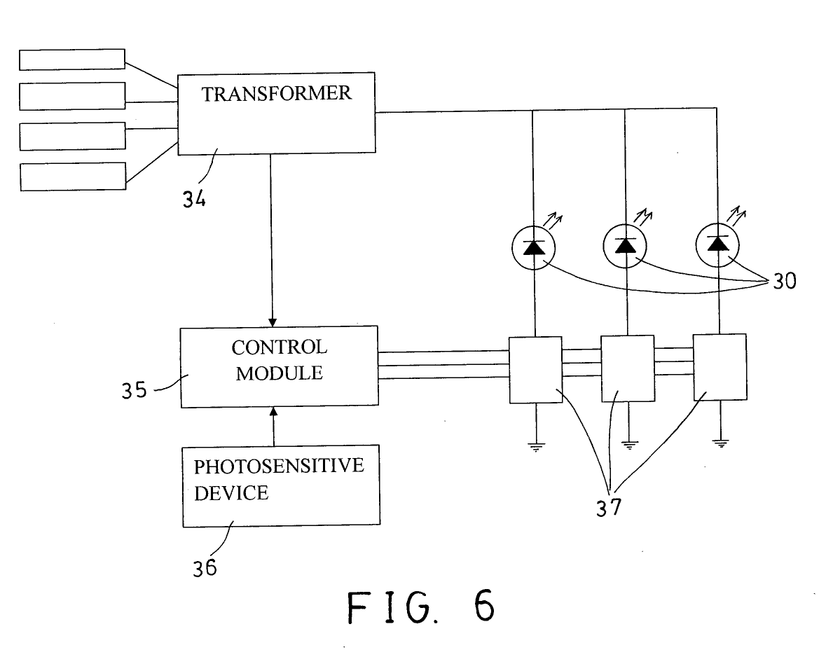

As shown in FIG. 6, the light members 30 are preferably arranged or coupled in parallel to each other, for allowing the other light members 30 still to be energized or worked even when one or more of the light members 30 have been damaged or become fail. The light device 20 further includes a transformer 34 coupled to the light members 30, for transforming an electric energy source, such as an alternative current (AC) into a direct current (DC), in order to energized and operate the light members 30.

The light device 20 further includes a central processor unit or a control module or control device 35 coupled to the transformer 34 and the light members 30, and/or a photosensitive device 36 coupled to the control module or control device 35, for actuating or triggering or operating the control module or control device 35 when detecting that the users are going toward or close to the light device 20 or the objects 10, for example.

The light device 20 may further include a number of driving devices 37 coupled to the light members 30 respectively, and coupled between the control module or control device 35 and the light members 30 respectively, in order to control or to actuate the light members 30 to generate various lights of different colors, or to generate steady or blinking or shining lights, for example.

It is to be noted that the light bulbs of the typical light devices may require an electric energy source up to 645 volts, in an electric current of 6-8 mA, and may consume an electric energy of about 15W. However, the light members 30 in accordance with the present invention may be energized by an electric energy source of about 3.6 volts only, in an electric current of 1A, and may consume an electric energy of about 6W, that is only about ⅖ of the typical light devices, such that the light members 30 of the light device 20 in accordance with the present invention may consume a greatly decreased electric energy.

In addition, the light members 30 in accordance with the present invention may generate a lightness or a brightness about ten times of that of the typical light devices, and will not generate a great heat that may normally be generated by the typical light devices, such that the working life of the light members 30 may be greatly increased. Furthermore, the light members 30 in accordance with the present invention may comprise a greatly decreased size or volume for allowing the light members 30 to be easily attached onto various objects 10.

In operation, the light members 30 may be controlled, by the control module or control device 35, or energized simultaneously, or in sequence or randomly, and may be actuated to generate various kinds of different colors, for decorative or for illuminating or for advertising purposes.

It is to be noted that the light members 30 that are engaged in or supported on the brackets 22 of the base board 21 may also be arranged in line or in series or in matrix arrangement relative to each other, in order to generate a strong light when some or all of the light members 30 have been energized or operated. In addition, not much heat will be generated by the light members 30 such that the working life of the light device may be increased.

Accordingly, the light device in accordance with the present invention includes a series of light members coupled in parallel to each other, for generating a stronger light and for increasing the working life of the light device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A light device comprising:
a base board including a plurality of brackets disposed thereon, and
a plurality of light members engaged in said brackets respectively, for attaching to said base board,
said light members being made of light emitting diodes and arranged in series, to generate a light of an increased brightness, and to have an increased working life.

2. The light device as claimed in claim 1, wherein said light members each includes two prongs extended therefrom, for coupling to said base board.

3. The light device as claimed in claim 2, wherein said light members each includes an indicator attached to each of said prongs, for showing the electrodes of said prongs.

4. The light device as claimed in claim 1 further comprising a control device coupled to control and to operate said light members.

5. The light device as claimed in claim 4 further comprising a plurality of driving devices coupled to said light members respectively, and coupled to said control device, to control and to operate said light members to generate lights of different colors.

6. The light device as claimed in claim 4 further comprising a transformer coupled to said light members respectively, and coupled to said control device, to provide an electric energy to said light members.

7. The light device as claimed in claim 4 further comprising a photosensitive device coupled to said control device.
